(19) United States
(12) Patent Application Publication
(10) Pub. No.: US 2015/0353078 A1
(43) Pub. Date: Dec. 10, 2015

(54) DRIVING ASSISTANCE APPARATUS

(71) Applicant: TOYOTA JIDOSHA KABUSHIKI KAISHA, Toyota-shi (JP)

(72) Inventor: Takuya KAMINADE, Susono-shi (JP)

(73) Assignee: TOYOTA JIDOSHA KABUSHIKI KAISHA, Toyota-shi (JP)

(21) Appl. No.: 14/706,489

(22) Filed: May 7, 2015

(30) Foreign Application Priority Data
Jun. 4, 2014 (JP) 2014-116211

(51) Int. Cl. B60W 30/00; G01S 13/06; G01S 13/93

(52) U.S. Cl. CPC B60W 30/00; G01S 13/931; G01S 13/06; B60W 2550/10

(57) ABSTRACT

A driving assistance apparatus includes: a moving-body detecting unit configured to detect a position of a moving body around a subject vehicle; a wall-position acquiring unit configured to acquire a position of a wall around the subject vehicle; an assistance-target determining unit configured to determine whether the detected moving body is an assistance target that exists ahead of the subject vehicle and approaches the subject vehicle from a lateral direction; a first specifying unit configured to determine whether the wall is positioned on a straight line connecting between a position of the moving body and the position of the subject vehicle to specify the moving body with the wall positioned on the straight line; and an assistance performing unit configured to perform driving assistance on an assistance target excluding the specified moving body.

### CROSS-REFERENCE TO RELATED APPLICATION(S)

The present application claims priority to and incorporates by reference the entire contents of Japanese Patent Application No. 2014-116211 filed in Japan on Jun. 4, 2014.

### BACKGROUND OF THE INVENTION

1. Field of the Invention

The present invention relates to a driving assistance apparatus.

2. Description of the Related Art

Conventionally, there is reported a technology that estimates a detection target as a virtual image (ghost) in the case where the distance from subject vehicle to the detection target, the existing area of the detection target, and the relative speed between the subject vehicle and the detection target satisfy predetermined conditions, so as to remove the estimated virtual image (here, the virtual image running side-by-side with the subject vehicle) from the assistance target of driving assistance (for example, in Japanese Patent Application Laid-open No. 2003-270342).

Incidentally, as illustrated in FIG. 1, assume the case where a radar device mounted on subject vehicle is used to detect a moving body (for example, other vehicle or similar vehicle) that exists at the vicinity of the subject vehicle via radio waves in an intersection with poor visibility. In the case where the radio wave reflected from the other vehicle ((1) in FIG. 1) is indirectly detected via a reflective object such as a wall, there might occur the event where the other vehicle is falsely recognized to exist in the position (the position of (2) in FIG. 1) where the other vehicle does not originally exist (that is, the event where the virtual image of the other vehicle is detected). For example, in the situation illustrated in FIG. 1, the radio wave reflected from the other vehicle that exists ahead of the subject vehicle on the left side is indirectly detected at the subject vehicle via the wall that exists on the right side of the subject vehicle. Accordingly, there occurs the event where the other vehicle is falsely recognized to exist ahead of the subject vehicle on the right side. That is, in the situation illustrated in FIG. 1, the subject vehicle falsely recognizes that the other vehicle, which is actually approaches from the left side, approaches from the right side.

When the moving body that exists at the vicinity of the subject vehicle is recognized based on this result of the radio wave indirectly detected via the reflective object such as a wall, there occurs the event where an assistance target for driving assistance is falsely recognized to exist in the position where the assistance target does not actually exist. This event can be the factor of the erroneous operation of the driving assistance. Thus, it is important to appropriately remove the virtual image of the moving body recognized in the position where the moving body does not actually exist from the assistance target for the driving assistance.

Here, the conventional technology (for example, in Japanese Patent Application Laid-open No. 2003-270342) assumes the case where the subject vehicle runs on a straight single road, and a target as the assistance target for the driving assistance runs within a limited range. It is possible to reduce most of the unnecessary assistance using a removal process of the target based on the existing area of the detection target, the distance from the subject vehicle to the detection target, and similar parameter.

However, as illustrated in FIG. 1, in the case of the driving assistance in an intersection with poor visibility, the intersection can employ various road widths and intersecting angles. Accordingly, like the conventional technology, it is difficult to uniquely set the region where the virtual image can be removed. This is because the existing position of the virtual image that runs side-by-side with the subject vehicle is limited in the conventional technology while it is difficult to appropriately set the region where the virtual image can be removed in the situation where there is a large region from front to back and from side to side like an intersection.

In the intersection, as illustrated in FIG. 1, there is also a virtual image approaching the subject vehicle from the lateral direction with respect to the travelling direction, other than the virtual image running side-by-side with the subject vehicle. Accordingly, the virtual image might not appropriately be removed with the same method as the conventional technology. This is because there might be a high reflective object such as a wall, a vending machine, and a guardrail at the vicinity of the subject vehicle in the intersection, and the virtual image does not only appear running side-by-side with the subject vehicle, but also might appear approaching from the lateral direction with respect to the travelling direction of the subject vehicle.

As just described, when a moving body is detected with a radar in an intersection, the virtual image of the moving body approaching from the lateral direction with respect to the subject vehicle might be observed from the position different from the existing position where the moving body originally exists due to the reflection of the radar. Accordingly, in the conventional driving assistance apparatus, it has been required to appropriately remove the virtual image from the assistance target so as to efficiently ensure the memory for saving the detection result of the assistance target, the communication volume for transmitting the detection result of the assistance target to a driving-assistance control device, and similar resource and so as not to perform incorrect driving assistance.

There is a need for a driving assistance apparatus that allows properly removing a virtual image of an assistance target approaching from the lateral direction with respect to a subject vehicle in an intersection.

### SUMMARY OF THE INVENTION

It is an object of the present invention to at least partially solve the problems in the conventional technology.

According to one aspect of the present invention, there is provided a driving assistance apparatus including: a moving-body detecting unit configured to detect a position of a moving body that exists at a vicinity of a subject vehicle via a radio wave, the subject vehicle being a vehicle on which the driving assistance apparatus is mounted; a wall-position acquiring unit configured to acquire a position of a wall that exists at a vicinity of the subject vehicle; an assistance-target determining unit configured to determine whether or not the moving body detected by the moving-body detecting unit is an assistance target that exists ahead of the subject vehicle and approaches the subject vehicle from a lateral direction; a first specifying unit configured to determine whether or not the wall is positioned on a straight line connecting between a position of the moving body and the position of the subject vehicle regarding the moving body determined as the assistance target by the assistance-target determining unit, so as to specify the moving body with the wall positioned on the straight line; and an assistance performing unit configured to perform driving assistance on an assistance target excluding the moving body specified by the first specifying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary situation that causes the problem of the present invention;

FIG. 2 is a block diagram illustrating an exemplary configuration of a driving assistance apparatus according to an embodiment of the present invention;

FIG. 3 is a diagram illustrating an exemplary refining process of an assistance target;

FIG. 4 is a diagram illustrating an exemplary refining process of the assistance target;

FIG. 5 is a diagram illustrating an exemplary process for specifying a virtual image of the assistance target;

FIG. 6 is a diagram illustrating an exemplary process for specifying the virtual image of the assistance target;

FIG. 7 is a flowchart illustrating an exemplary driving assistance process according to the embodiment of the present invention; and

FIG. 8 is a flowchart illustrating an exemplary driving assistance process according to the embodiment of the present invention.

### DETAILED DESCRIPTION OF THE PREFERRED EMBODIMENTS

Hereinafter, a description will be given of an embodiment of a driving assistance apparatus according to the present invention in detail based on the accompanying drawings. This embodiment does not limit the invention. The constituent elements in the embodiment described below include various modifications that will readily occur to those skilled in the art or modifications substantially similar thereto.

### Embodiment

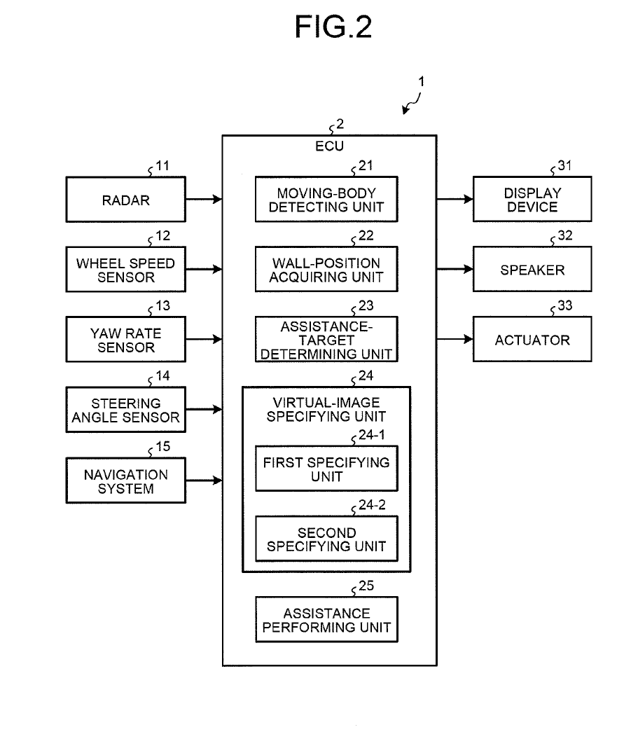

A description will be given of the configuration of the driving assistance apparatus according to the embodiment of the present invention with reference to FIG. 2 to FIG. 6. FIG. 2 is a block diagram illustrating an exemplary configuration of the driving assistance apparatus according to the embodiment of the present invention.

As illustrated in FIG. 2, a driving assistance apparatus 1 according to this embodiment includes an electronic control unit (ECU) 2, a radar 11, a wheel speed sensor 12, a yaw rate sensor 13, a steering angle sensor 14, a navigation system 15, a display device 31, a speaker 32, and an actuator 33. This driving assistance apparatus 1 is mounted on a vehicle (subject vehicle).

The ECU 2 couples to the radar 11 as a sensor for measuring the surrounding environment. The radar 11 is a device for detecting the object at the vicinity of the subject vehicle. The vicinity of the subject vehicle is at least the front, and the objects on the side and on the back can also be detected as necessary. The radar 11 can employ, for example, a laser radar and a millimeter-wave radar. The radar 11 transmits a radio wave (electromagnetic wave) while scanning within the scanning range of the radar 11 and receives the reflected wave that reflects and returns from the object, so as to detect information related to the transmission and reception. Then, the radar 11 transmits the detected transmission/reception information to the ECU 2 as a radar signal.

The ECU 2 also couples to the wheel speed sensor 12, the yaw rate sensor 13, and the steering angle sensor 14. The wheel speed sensor 12 is a sensor that detects the rotation speed of the wheel of the subject vehicle. The wheel speed sensor 12 transmits the detected rotation speed of the wheel to the ECU 2 as a wheel speed signal. The yaw rate sensor 13 is a sensor that detects the yaw rate of the subject vehicle. The yaw rate sensor 13 transmits the detected yaw rate to the ECU 2 as a yaw rate signal. The steering angle sensor 14 is a sensor that detects a steering angle of the subject vehicle. For example, the steering angle sensor 14 detects a rotation angle (steering angle) of a steering shaft so as to detect a steering angle of the subject vehicle. The steering angle sensor 14 transmits the detected steering angle to the ECU 2 as a steering angle signal.

Further, the ECU 2 couples to the navigation system 15. The navigation system 15 has a basic function that guides the subject vehicle to a predetermined destination. The navigation system 15 includes at least an information storage medium, an arithmetic processing unit, and an information detection device. The information storage medium stores map information required for running of the vehicle. The arithmetic processing unit computes route information from the subject vehicle to the predetermined destination. The information detection device includes a GPS antenna, a GPS receiver, and similar member for detecting the current position of the subject vehicle, the road condition, and similar value with radio navigation. In this embodiment, the map information stored in the information storage medium includes, for example, at least information related to the positions of intersections, existences and positions of roadside structures such as walls and guardrails corresponding to the road shape, and similar parameter. The navigation system 15 transmits various information obtained in the arithmetic processing unit, the information storage medium, the information detection device, and similar member to the ECU 2. In this embodiment, the various information transmitted to the ECU 2 from the navigation system 15 includes, for example, the route information from the subject vehicle to the predetermined destination, the location information of intersections, the location information of roadside structures such as walls, the location information of the subject vehicle, and similar information. However, the various information is not limited to these.

The display device 31 is a display installed within the vehicle, and displays various information corresponding to a driving assistance signal output from the ECU 2 so as to notify the driver. The speaker 32 outputs predetermined audio corresponding to the driving assistance signal from the ECU 2. As just described, the display device 31 and the speaker 32 display a screen and output audio as a human machine interface (HMI) such as a head-up display (HUD). The actuator 33 is a brake actuator, an accelerator actuator, or a steering actuator that intervenes in the driving operation of the driver based on the driving assistance signal from the ECU 2 so as to drive the brake, the accelerator, or the steering of the subject vehicle. While not illustrated here, a vibration device may be mounted in a predetermined position such as the steering wheel and the driving seat in this embodiment. In this case, the vibration device vibrates the steering wheel or the driving seat corresponding to the driving assistance signal output from the ECU 2 so as to allow drawing the driver's attention.

The ECU 2 includes a central processing unit (CPU), various memories, and similar member, and integrally controls the driving assistance apparatus 1. The ECU 2 loads the respective application programs stored in the memory and causes the CPU to execute the application programs. The ECU 2 includes a moving-body detecting unit 21, a wall-position acquiring unit 22, an assistance-target determining unit 23, a virtual-image specifying unit 24, and an assistance performing unit 25. Here, the virtual-image specifying unit 24 further includes a first specifying unit 24-1 and a second specifying unit 24-2. Here, in this embodiment, the moving-body detecting unit 21 corresponds to the moving-body detecting unit described in the claims. The wall-position acquiring unit 22 corresponds to the wall-position acquiring unit. The assistance-target determining unit 23 corresponds to the assistance-target determining unit. The first specifying unit 24-1 corresponds to the first specifying unit. The second specifying unit 24-2 corresponds to the second specifying unit. The assistance performing unit 25 corresponds to the assistance performing unit.

In the ECU 2, the moving-body detecting unit 21 is a moving-body detecting unit that detects the position of the moving body existing at the vicinity of the subject vehicle via radio waves. Specifically, the moving-body detecting unit 21 detects the position of the object existing at the vicinity of the subject vehicle based on the radar signal corresponding to the transmission/reception information of the radio wave detected by the radar 11 so as to recognize the object whose the position changes within a predetermined period as a moving body, and then detects the position of this moving body. For example, the moving-body detecting unit 21 detects the direction of the radio wave received by the radar 11, which is mounted on the subject vehicle, as the direction in which the moving body exists based on the radar signal. Subsequently, the moving-body detecting unit 21 detects the distance from the subject vehicle to the moving body based on the time taken until the radio wave emitted to the direction in which the moving body exists reflects at the moving body and returns. Subsequently, the moving-body detecting unit 21 detects the position of the moving body with respect to the subject vehicle based on the direction in which the detected moving body exists and the distance from the subject vehicle to the moving body. Further, the moving-body detecting unit 21 may measure the speed of the moving body. In this case, the moving-body detecting unit 21 uses at least two points of the position of the detected moving body to measure the distance between the two points thereof, and measures the speed of the moving body based on the time taken for the movement of the measured distance between the two points by the target moving body.

In the ECU 2, the wall-position acquiring unit 22 is a wall-position acquiring unit that acquires the position of the wall existing at the vicinity of the subject vehicle. Specifically, the wall-position acquiring unit 22 may acquire the position of the wall existing at the vicinity of the subject vehicle based on the map information stored in the information storage medium of the navigation system 15, or may acquire the position of the wall existing at the vicinity of the subject vehicle based on the radar signal corresponding to the transmission/reception information of the radio wave detected by the radar 11. Further, the wall-position acquiring unit 22 acquires information indicative of the positional relationship between the subject vehicle and the wall including the extending direction of the wall existing at the vicinity of the subject vehicle, the distance between the subject vehicle and the wall, and similar information, based on the acquired position of the wall using the navigation system 15 or the radar 11.

In the ECU 2, the assistance-target determining unit 23 is an assistance-target determining unit that determines whether or not the moving body detected by the moving-body detecting unit 21 is the assistance target that exists ahead of the subject vehicle and approaches the subject vehicle from the lateral direction. Specifically, the assistance-target determining unit 23 determines whether or not the target moving body is the assistance target that exists ahead of the subject vehicle and approaches the subject vehicle from the lateral direction, based on the detected position of the moving body and the measured speed of the moving body by the moving-body detecting unit 21. In this embodiment, the moving body includes, for example, the other vehicle as a vehicle other than the subject vehicle, a motorcycle, a bicycle, a pedestrian, and similar moving body.

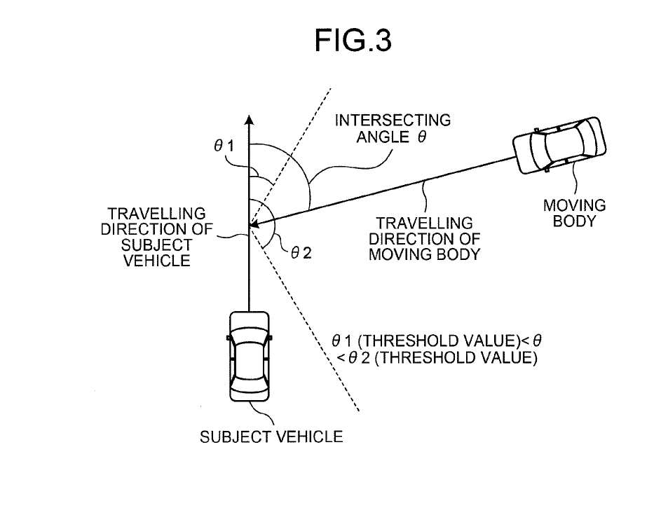

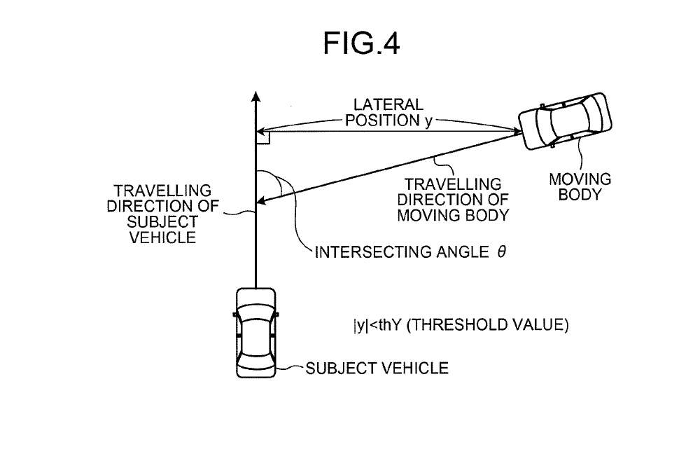

Here, a description will be given of an exemplary refining process of the assistance target performed by the assistance-target determining unit 23 with reference to FIG. 3 and FIG. 4. FIG. 3 and FIG. 4 are diagrams illustrating an exemplary refining process of the assistance target.

As illustrated in FIG. 3, the assistance-target determining unit 23 calculates the travelling direction of the moving body based on the position and the speed of the moving body. Subsequently, the assistance-target determining unit 23 calculates an intersecting angle θ formed by: the travelling direction of the moving body; and the travelling direction of the subject vehicle while the origin is the center of the vehicle-width direction of the subject vehicle. Subsequently, the assistance-target determining unit 23 determines the moving body satisfying the condition where the intersecting angle θ is within a predetermined range (θ1<θ<θ2) as the assistance target of the driving assistance. Here, the travelling direction of the subject vehicle is calculated based on the position and the speed of the subject vehicle similarly to the travelling direction of the moving body. Here, in this embodiment, the position of the subject vehicle is measured by the ECU 2 using a subject-vehicle-position specifying device such as a global positioning system (GPS) included in the navigation system 15, which is mounted on the subject vehicle. The speed of the subject vehicle is measured by the ECU 2 based on the wheel speed signal corresponding to the rotation speed of the wheel detected by the wheel speed sensor 12.

In this embodiment, a lower-limit threshold value θ1 and an upper-limit threshold value θ2, which specify the predetermined range of the intersecting angle θ, are set to the angles to the extent that the moving body approaching the subject vehicle from the direction other than the lateral direction can be removed from the assistance target. For example, in the case where the moving body is a vehicle other than the subject vehicle, the angle of the threshold value θ1 is set to the angle that allows discriminating between at least the oncoming vehicle approaching the subject vehicle from the front side and the vehicle approaching the subject vehicle from the lateral direction of the vehicle. The angle of the threshold value θ2 is set to the angle that allows discriminating between at least the following vehicle approaching from the back side of the subject vehicle and the vehicle approaching the subject vehicle from the lateral direction of the vehicle.

Further, as illustrated in FIG. 4, the assistance-target determining unit 23 may determine the moving body satisfying the condition where a lateral position y of the moving body with respect to the subject vehicle is within a predetermined threshold value (|y|<thY) as the assistance target, in addition to the condition where the intersecting angle θ is within the predetermined range (θ1<θ<θ2). Specifically, the assistance-target determining unit 23 calculates the travelling direction of the moving body based on the position and the speed of the moving body. Subsequently, the assistance-target determining unit 23 calculates the intersecting angle θ formed by: the travelling direction of the moving body; and the travelling direction of the subject vehicle while the origin is the center of the vehicle-width direction of the subject vehicle. Subsequently, the assistance-target determining unit 23 determines the moving body that satisfies the condition where the intersecting angle θ is within the predetermined range (θ1<θ<θ2) and satisfies the condition where the lateral position y is within the predetermined threshold value (|y|<thY), as the assistance target. In this embodiment, the lateral position y is the distance corresponding to the shortest distance from the extended line indicative of the travelling direction of the subject vehicle to the position of the moving body. The predetermined threshold value thY is set to the distance to the extent that the assistance target can exclude the moving body that is less likely to collide with the subject vehicle due to a relatively large distance from the subject vehicle among the moving bodies approaching the subject vehicle from the lateral direction.

Referring again to FIG. 2, in the ECU 2, the virtual-image specifying unit 24 is a virtual-image specifying unit that specifies the virtual image of the moving body to be removed from the assistance target of the driving assistance among the moving bodies determined as the assistance target of the driving assistance by the assistance-target determining unit 23. In this embodiment, the virtual-image specifying unit 24 includes the first specifying unit 24-1 and the second specifying unit 24-2. The first specifying unit 24-1 is a first specifying unit that determines whether or not the wall is positioned on the straight line connecting between the position of the moving body and the position of the subject vehicle so as to specify the moving body with the wall positioned on this straight line, regarding the moving body determined as the assistance target of the driving assistance by the assistance-target determining unit 23. The second specifying unit 24-2 is a second specifying unit that inverts the position of the moving body specified by the first specifying unit 24-1 with respect to the travelling direction of subject vehicle while the reflection point where the radio wave used when the position of this moving body is detected is used as a basing point, to determine whether or not the inverted position of the moving body is within a blind spot region of the subject vehicle so as to specify the moving body within the blind spot region. In this embodiment, the virtual-image specifying unit 24 estimates the moving body specified by the first specifying unit 24-1 as the virtual image of the moving body to be removed from the assistance target of the driving assistance. More preferably, the virtual-image specifying unit 24 determines the moving body specified by the second specifying unit 24-2 as the virtual image of the moving body to be removed from the assistance target of the driving assistance.

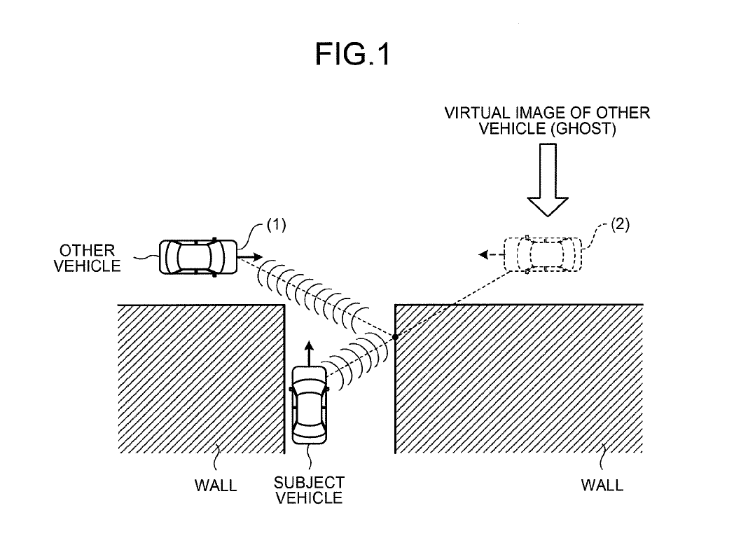

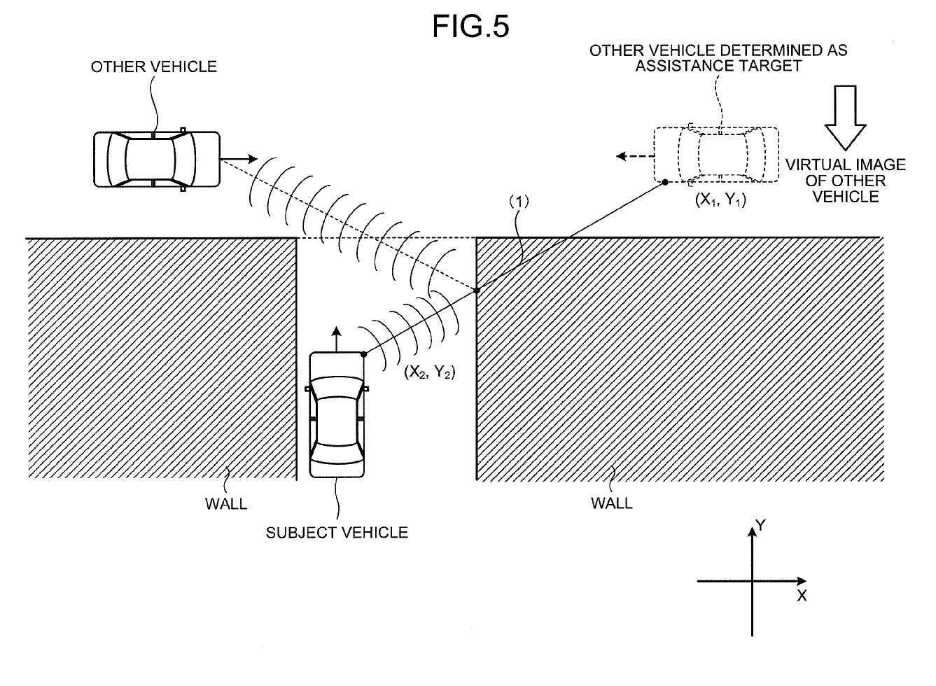

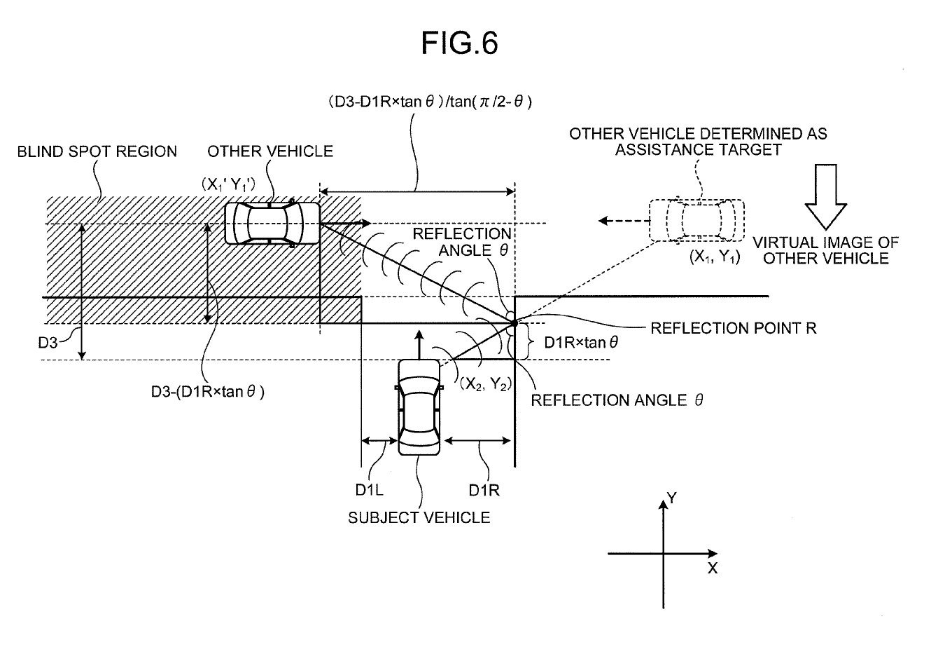

Here, a description will be given of the process for specifying the virtual image of the moving body by the first specifying unit 24-1 and the second specifying unit 24-2 with reference to FIG. 5 and FIG. 6. FIG. 5 and FIG. 6 are diagrams illustrating an exemplary process for specifying the virtual image of the assistance target. Firstly, the virtual-image specifying process by the first specifying unit 24-1 will be described with reference to FIG. 5. Next, the virtual-image specifying process by the second specifying unit 24-2 will be described with reference to FIG. 6. Similarly to FIG. 1 described above, FIG. 5 and FIG. 6 assume the case where the moving body existing at the vicinity of the subject vehicle (for example, the other vehicle and similar vehicle) is detected in an intersection with poor visibility via radio waves using the radar 11 mounted on the subject vehicle.

Firstly, as illustrated in FIG. 5, the first specifying unit 24-1 generates a straight line (the straight line of (1) in FIG. 5) connecting between the position (“X₁, Y₁” in FIG. 5) of the moving body (in FIG. 5, the other vehicle as the assistance target existing ahead of the subject vehicle on the right side) and the position (“X₂, Y₂^{”} in FIG. 5) of the subject vehicle. The moving body is determined as the assistance target of the driving assistance by the assistance-target determining unit 23, and approaches from the lateral direction with respect to the travelling direction of the subject vehicle. This position of the subject vehicle may be the position corresponding to the barycentric position of the subject vehicle specified by the navigation system 15, but is preferred to be the position where the radio wave emitted from the radar 11 mounted on the subject vehicle is received (that is, the mounted position of the radar 11 that transmits and receives the radio wave). Subsequently, the first specifying unit 24-1 determines whether or not the position of the wall (in FIG. 5, the wall existing on the right side of the subject vehicle) acquired by the wall-position acquiring unit 22 overlaps on the straight line. In FIG. 5, the first specifying unit 24-1 determines that the wall overlaps on the straight line connecting between: the position “X₁, Y₁” of the other vehicle determined as the assistance target; and the position “X₂, Y₂” of the subject vehicle, so as to estimate the other vehicle (in FIG. 5, the other vehicle existing ahead of the subject vehicle on the right side), which is determined as the assistance target, as the virtual image. This is because, in the case where the reflective object such as the wall exists between the position of the assistance target and the position of the subject vehicle in the detected direction where the assistance target exists, the other vehicle determined as the assistance target can be estimated as the virtual image of the other vehicle indirectly detected via the reflective object such as the wall. Here, the expression “indirectly detect” means that the radio wave emitted from the radar 11 is reflected at the moving body as a detection target and then detected by the radar 11 via at least one reflective object such as the wall.

Subsequently, as illustrated in FIG. 6, the second specifying unit 24-2 predicts the position where this other vehicle originally exists, regarding the other vehicle of the assistance target estimated as the virtual image of the other vehicle by the first specifying unit 24-1. In the case where this predicted position of the other vehicle belongs to the inside of the blind spot region with respect to the subject vehicle, the second specifying unit 24-2 determines the virtual image of the other vehicle.

Specifically, the second specifying unit 24-2 inverts the position of the moving body (in FIG. 6, the other vehicle as the assistance target existing ahead of the subject vehicle on the right side), which is estimated as the virtual image of the other vehicle by the first specifying unit 24-1, with respect to the travelling direction of the subject vehicle while a reflection point R of the radio wave used when the position (“X₁, Y₁” in FIG. 6) of the moving body is detected is used as the basing point. The position of this reflection point R corresponds to the position of intersection between: the straight line connecting between the position (“X₂, Y₂” in FIG. 6) of the vehicle and the position (“X₁, Y₁” in FIG. 6) of the target moving body; and the straight line corresponding to the edge of the wall. The reflection angle θ of the radio wave reflected at the position of the reflection point R corresponds to the intersecting angle between: the straight line connecting between the position of the vehicle and the position of the target moving body; and the straight line corresponding to the edge of the target wall. The second specifying unit 24-2 predicts the reflex path of the radio wave reflected in the direction at the reflection angle θ at the reflection point R, so as to predict the position where the other vehicle originally exists.

For example, as illustrated in FIG. 6, when D1R corresponding to the distance between: the wall on the right side where the reflection point R exists; and the subject vehicle; is obtained from the information indicative of the positional relationship between the subject vehicle and the wall based on the position of the wall acquired by the wall-position acquiring unit 22. The second specifying unit 24-2 calculates D1R×tan θ corresponding to the distance on the Y-axis from the position of subject vehicle to the reflection point R based on D1R and the reflection angle θ. When a D3 corresponding to the distance to the extended line, which starts from the center of the vehicle-width direction of the other vehicle and corresponds to the travelling direction of the other vehicle, is obtained, the second specifying unit 24-2 calculates D3−(D1R×tan θ) corresponding to the distance on the Y-axis from the position where the other vehicle originally exists to the reflection point R based on D3 and D1R×tan θ. The second specifying unit 24-2 calculates (D3−D1R×tan θ)/tan(π/2−θ) corresponding to the distance on the X-axis from the position where the other vehicle originally exists to the reflection point R based on calculated D3−(D1R×tan θ) and the reflection angle θ. Based on the various parameters D1R, D3, (D3−D1R×tan θ)/tan(π/2−θ) thus obtained, the second specifying unit 24-2 predicts the position where the other vehicle originally exists with reference to the position of the subject vehicle. For example, in FIG. 6, assuming that the position “X₂, Y₂” of r subject vehicle is the reference, a position “X₁′, Y₁′” where the other vehicle originally exists is the position that is moved from the position “X₂, Y₂” of the subject vehicle by D3 toward the positive direction of the Y-axis and moved toward the negative direction of the X-axis by [(D3−D1R×tan θ)/tan(π/2−θ)]−D1R.

As illustrated in FIG. 6, the second specifying unit 24-2 determines whether or not the inverted position (“X₁′, Y₁′” in FIG. 6) of the moving body is within the blind spot region (the region of the hatched portion in FIG. 6) of the subject vehicle, so as to specify the moving body within the blind spot region. The blind spot region is the region where the radar 11 mounted on the subject vehicle cannot directly detect the object. Here, the expression “can directly detect” means that the radio wave emitted from the radar 11 is reflected at the moving body as a detection target and then can be detected by the radar 11 not via any reflective object such as the wall. In this embodiment, the blind spot region is set to be on the opposite side of the existing position of the reflection point R with respect to the subject vehicle. This blind spot region is set taking into consideration the mounted position of the radar 11, which is mounted on the subject vehicle, and the position of the wall acquired by the wall-position acquiring unit 22 (in FIG. 6, the position of the wall on the left side of the subject vehicle). In the example of FIG. 6, the region of the hatched portion, which exists on the far side with respect to the reflection point R toward the travelling direction of the subject vehicle and on the far side with respect to a distance D1L between the subject vehicle and the left-side wall toward the left side direction of the subject vehicle, is set as the blind spot region. In the case where the inverted position of the moving body, that is, the position “X₁′, Y₁′” where the other vehicle originally exists is within this blind spot region, the second specifying unit 24-2 determines the other vehicle of the assistance target, which is used as the inversion target, as the virtual image.

Referring again to FIG. 2, in the ECU 2, the assistance performing unit 25 is an assistance performing unit that performs the driving assistance on the assistance target excluding the moving body specified by the first specifying unit 24-1 (that is, the moving body estimated as the virtual image). More preferably, the assistance performing unit 25 performs the driving assistance on the assistance target excluding the moving body specified by the second specifying unit 24-2 (that is, the moving body determined as the virtual image). The assistance performing unit 25 transmits the driving assistance signal, which corresponds to the content of the driving assistance, to the display device 31, the speaker 32, and the actuator 33 to control these members so as to perform the driving assistance. In this embodiment, the driving assistance includes the assistance indicating that the position of the assistance target exists in either of the right and left directions with respect to the subject vehicle. For example, the assistance performing unit 25 notifies the driver about the existence of the assistance target in either of the right and left directions by indication for drawing the driver's attention displayed on the display, alarm sound output from the speaker, and similar method. In addition, the assistance performing unit 25 may intervene in the driving operation to drive the brake, the accelerator, or the steering of the subject vehicle, so as to perform the driving assistance for avoiding the collision with the moving body determined as the assistance target.

Here, the assistance performing unit 25 may employ a control that determines the degree of risk to the assistance target before the driving assistance is performed and then performs the driving assistance in the case where the degree of risk is high. For example, the assistance performing unit 25 calculates a collision prediction time (D/V) based on a distance D to the assistance target approaching the subject vehicle from the lateral direction and a relative speed V between the subject vehicle and the assistance target (for example, the other vehicle). Then, in the case where the calculated collision prediction time is smaller than a predetermined threshold value y, the assistance performing unit 25 determines that the degree of risk is high. The predetermined threshold value y is set to the time to the extent that it is determined that there is a high possibility that the collision between the subject vehicle and the assistance target cannot be avoided in the case where the driving assistance, for example, drawing the driver's attention is not performed. In addition, the assistance performing unit 25 may determine that the degree of risk is high in the case where the assistance target exists within a dangerous region set to a predetermined range ahead of the subject vehicle.

Here, in this embodiment, the ECU 2 may further include a position inversion unit that inverts the position of the moving body specified as the virtual image by the virtual-image specifying unit 24 with respect to the travelling direction of the subject vehicle while the origin is the reflection point of the radio wave used when the position of the moving body is detected. In this case, the assistance performing unit 25 may perform the driving assistance on the assistance target including the moving body corresponding to the virtual image whose the position is inverted by the position inversion unit.

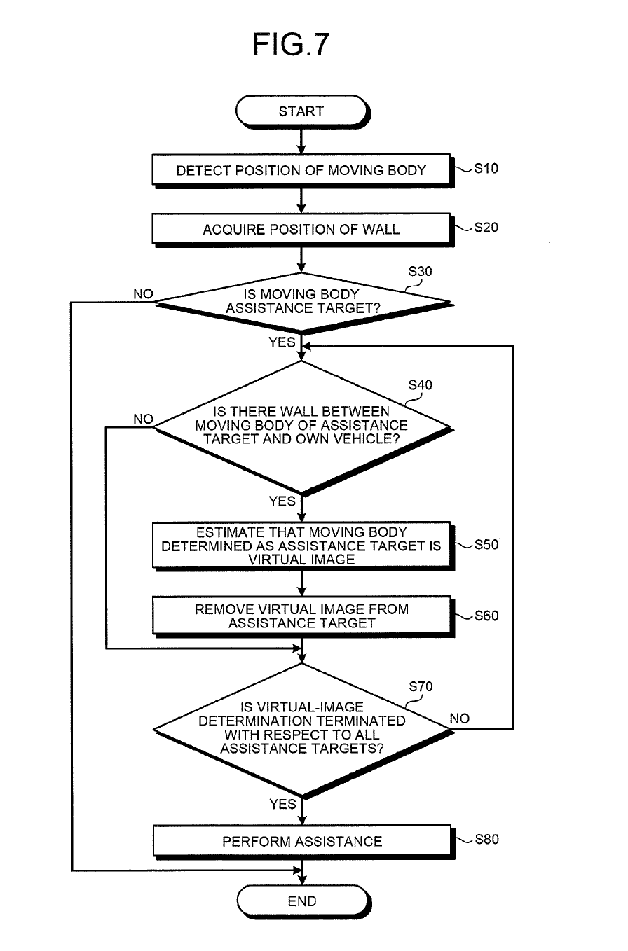

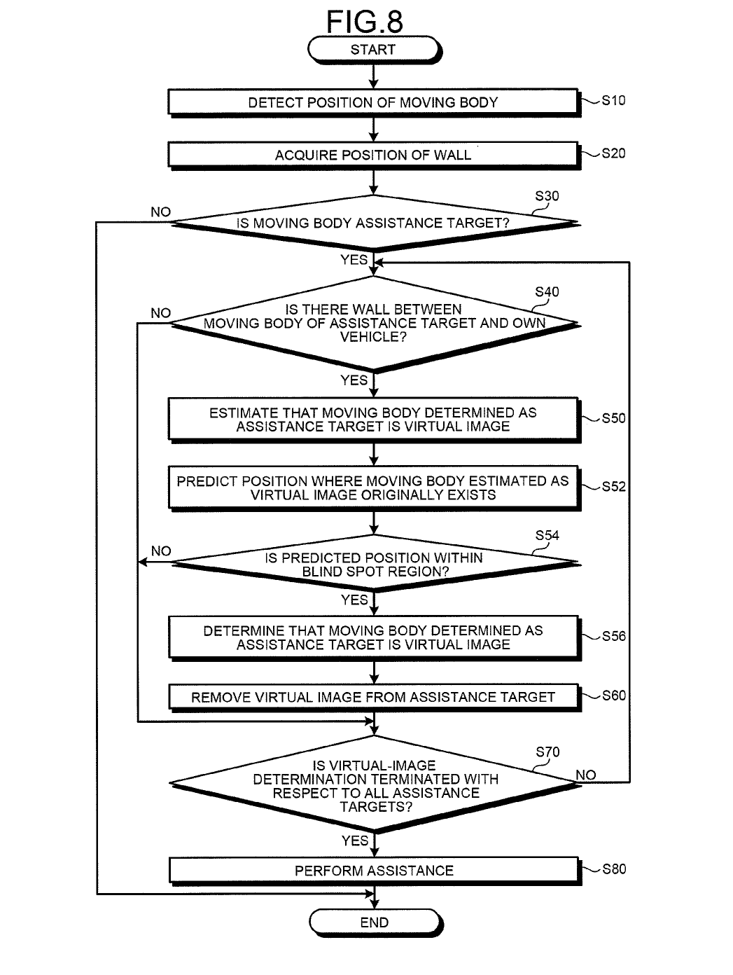

Next, a description will be given of an exemplary process executed by the driving assistance apparatus according to the embodiment of the present invention with reference to FIG. 7 and FIG. 8. FIG. 7 and FIG. 8 are flowcharts illustrating an exemplary driving assistance process according to the embodiment of the present invention. The following processes illustrated in FIG. 7 and FIG. 8 are repeatedly executed for a short operation period at predetermined intervals.

Firstly, a description will be given of the driving assistance process illustrated in FIG. 7. In the driving assistance process illustrated in FIG. 7, the driving assistance is performed on the assistance targets excluding the moving body specified by the first specifying unit 24-1 in the virtual-image specifying unit 24.

As illustrated in FIG. 7, the moving-body detecting unit 21 detects the position of the moving body existing at the vicinity of the subject vehicle using the radio wave (in step S10). For example, the situation illustrated in FIG. 5 will be described as an example. In step S10, while the moving body actually exists ahead of the subject vehicle on the left side, the wall positioned on the right side of the subject vehicle becomes the reflective object the radio wave. Accordingly, the moving-body detecting unit 21 detects the position of the virtual image of the other vehicle, which is detected to exist ahead of the subject vehicle on the right side, as the position (“X₁, Y₁” in the example of FIG. 5) of the moving body.

The wall-position acquiring unit 22 acquires the position of the wall existing at the vicinity of the subject vehicle (in step S20). In step S20, the wall-position acquiring unit 22 may acquire the position of the wall existing at the vicinity of the subject vehicle (in FIG. 5, the position of the wall existing in the right-left direction of the subject vehicle) based on the map information stored in the information storage medium of the navigation system 15, or may acquire the position of the wall existing at the vicinity of the subject vehicle based on the radar signal corresponding to the transmission/reception information of the radio wave detected by the radar 11. Further, based on the position of the wall acquired using the navigation system 15 or the radar 11, the wall-position acquiring unit 22 acquires the information indicative of the positional relationship between the subject vehicle and the wall including the extending direction of the wall existing at the vicinity of the subject vehicle, the distance between the subject vehicle and the wall, and similar information.

The assistance-target determining unit 23 determines whether or not the moving body detected by the moving-body detecting unit 21 in step S10 is the assistance target that exists ahead of the subject vehicle and approaches the subject vehicle from the lateral direction (in step S30). In step S30, for example, as illustrated in FIG. 3, the assistance-target determining unit 23 calculates the travelling direction of the moving body based on the position and the speed of the moving body. Subsequently, the assistance-target determining unit 23 calculates the intersecting angle θ formed by: the travelling direction of the moving body; and the travelling direction of the subject vehicle while the origin is the center of the vehicle-width direction of the subject vehicle. Subsequently, the assistance-target determining unit 23 determines whether or not the intersecting angle θ satisfies the condition where the angle is within the predetermined range (θ1<θ<θ2).

In step S30, in the case where it is determined that the intersecting angle θ is not within the predetermined range (θ1<θ<θ2) (No in step S30), the assistance-target determining unit 23 determines that the target moving body is not the assistance target that exists ahead of the subject vehicle and approaches the subject vehicle from the lateral direction and then terminates this process. On the other hand, in step S30, in the case where it is determined that the intersecting angle θ is within the predetermined range (θ1<θ<θ2) (Yes in step S30), the assistance-target determining unit 23 determines that the target moving body is the assistance target that exists ahead of the subject vehicle and approaches the subject vehicle from the lateral direction, and proceeds to the subsequent process in step S40.

Regarding the moving body determined as the assistance target of the driving assistance by the assistance-target determining unit 23 in step S30, the first specifying unit 24-1 in the virtual-image specifying unit 24 determines whether or not the wall is positioned on the straight line connecting between the position of the moving body and the position of the subject vehicle, so as to specify the moving body with the wall positioned on this straight line (in step S40). For example, in the situation illustrated in FIG. 5 will be described as an example. In step S40, the first specifying unit 24-1 generates a straight line (the straight line of (1) in FIG. 5) connecting between the position (“X₁, Y₁” in FIG. 5) of the moving body (in FIG. 5, the other vehicle as the assistance target existing ahead of the subject vehicle on the right side) and the position (“X₂, Y₂” in FIG. 5) of the subject vehicle. The moving body is determined as the assistance target of the driving assistance by the assistance-target determining unit 23, and approaches from the lateral direction with respect to the travelling direction of the subject vehicle. Subsequently, the first specifying unit 24-1 determines whether or not the position of the wall (in FIG. 5, the wall existing on the right side of the subject vehicle) acquired by the wall-position acquiring unit 22 overlaps on the straight line.

In step S40, in the case where it is determined that the wall overlaps on the straight line connecting between the position of the target moving body determined as the assistance target and the position of the subject vehicle (Yes in step S40), the first specifying unit 24-1 estimates this moving body (in FIG. 5, the other vehicle existing ahead of the subject vehicle on the right side), which is determined as the assistance target, as the virtual image (in step S50). Subsequently, the process proceeds to the subsequent process in step S60. In subsequent step S60, the moving body estimated as the virtual image in step S50 by the assistance performing unit 25 is set to be removed from the assistance target so as not to be included in the assistance target. Accordingly, when the driving assistance is performed in step S80 described below, the driving assistance is not performed on the virtual image.

On the other hand, in step S40, in the case where it is determined that the wall does not overlap on the straight line connecting between the position of the target moving body determined as the assistance target and the position of the subject vehicle (No in step S40), the first specifying unit 24-1 estimates that this moving body determined as the assistance target is not the virtual image and proceeds to the subsequent process in step S70 without setting the moving body to be removed from the assistance target.

The assistance performing unit 25 determines whether or not the virtual-image determination process in step S40 is performed on all the moving bodies determined as the assistance targets in step S30 before performing the driving assistance (in step S70). In step S70, in the case where it is determined that the virtual-image determination process is not terminated with respect to all the assistance targets (No in step S70), the process returns to the process in step S40. On the other hand, in the case where it is determined that the virtual-image determination process is terminated with respect to all the assistance targets in step S70 (Yes in step S70), the assistance performing unit 25 performs the driving assistance on the assistance targets excluding the moving body (that is, the moving body estimated as the virtual image) specified by the first specifying unit 24-1 in step S40 (in step S80). In step S80, the driving assistance to be performed includes the assistance indicating that the position of the assistance target exists in either of the right and left directions with respect to the subject vehicle. Subsequently, this process terminates.

Next, a description will be given of the driving assistance process illustrated in FIG. 8. In the driving assistance process illustrated in FIG. 8, the driving assistance is performed on the assistance targets excluding the moving body specified by the second specifying unit 24-2 in the virtual-image specifying unit 24. In the process of FIG. 8, regarding the moving body estimated as the virtual image as described in FIG. 7 above, the second specifying unit 24-2 further predicts the position where the moving body estimated as the virtual image originally exists. Subsequently, it is determined whether or not this predicted position is within the blind spot region so as to execute the process for determining the estimation result of the virtual image by the first specifying unit 24-1. Accordingly, the process in FIG. 8 described as follows allows more accurately specifying the virtual image compared with the process for specifying the virtual image using the first specifying unit 24-1 described in FIG. 7 above alone.

As illustrated in FIG. 8, the moving-body detecting unit 21 detects the position of the moving body existing at the vicinity of the subject vehicle using the radio wave (in step S10). For example, the situation illustrated in FIG. 6 will be described as an example. In step S10, while the moving body actually exists ahead of the subject vehicle on the left side, the wall positioned on the right side of the subject vehicle becomes the reflective object the radio wave. Accordingly, the moving-body detecting unit 21 detects the position of the virtual image of the other vehicle, which is detected to exist ahead of the subject vehicle on the right side, as the position (“X₁, Y₁” in the example of FIG. 6) of the moving body.

The wall-position acquiring unit 22 acquires the position of the wall existing at the vicinity of the subject vehicle (in step S20). In step S20, based on the position of the wall acquired using the navigation system 15 or the radar 11, the wall-position acquiring unit 22 acquires the information indicative of the positional relationship between the subject vehicle and the wall including the extending direction of the wall existing at the vicinity of the subject vehicle, the distance between the subject vehicle and the wall, and similar information. For example, the situation illustrated in FIG. 6 will be described as an example. In step S20, the wall-position acquiring unit 22 acquires at least the distance D1R between the subject vehicle and the right-side wall and the distance D1L between the subject vehicle and the left-side wall.

The assistance-target determining unit 23 determines whether or not the moving body detected by the moving-body detecting unit 21 in step S10 is the assistance target that exists ahead of the subject vehicle and approaches the subject vehicle from the lateral direction (in step S30). In step S30, in the case where the assistance-target determining unit 23 determines that the target moving body is not the assistance target that exists ahead of the subject vehicle and approaches the subject vehicle from the lateral direction (No in step S30), this process terminates. On the other hand, in step S30, in the case where the assistance-target determining unit 23 determines that the target moving body is the assistance target that exists ahead of the subject vehicle and approaches the subject vehicle from the lateral direction (Yes in step S30), the process proceeds to the subsequent process in step S40.

Regarding the moving body determined as the assistance target of the driving assistance by the assistance-target determining unit 23 in step S30, the first specifying unit 24-1 in the virtual-image specifying unit 24 determines whether or not the wall is positioned on the straight line connecting between the position of the moving body and the position of the subject vehicle, so as to specify the moving body with the wall positioned on this straight line (in step S40). For example, in the situation illustrated in FIG. 6 will be described as an example. In step S40, the first specifying unit 24-1 determines whether or not the position of the wall (in FIG. 6, the wall existing on the right side of the subject vehicle) acquired by the wall-position acquiring unit 22 overlaps on a straight line connecting between the position (“X₁, Y₁” in FIG. 6) of the moving body and the position (“X₂, Y₂” in FIG. 6) of the subject vehicle.

In step S40, in the case where it is determined that the wall overlaps on the straight line connecting between the position of the target moving body determined as the assistance target and the position of the subject vehicle (Yes in step S40), the first specifying unit 24-1 estimates this moving body (in FIG. 6, the other vehicle existing ahead of the subject vehicle on the right side), which is determined as the assistance target, as the virtual image (in step S50). Subsequently, the process proceeds to the subsequent process in step S52. On the other hand, in step S40, in the case where it is determined that the wall does not overlap on the straight line connecting between the position of the target moving body determined as the assistance target and the position of the subject vehicle (No in step S40), the first specifying unit 24-1 estimates that this moving body determined as the assistance target is not the virtual image and proceeds to the subsequent process in step S70.

Regarding the moving body estimated as the virtual image by the first specifying unit 24-1 in step S50, the second specifying unit 24-2 of the virtual-image specifying unit 24 predicts the position where this moving body originally exists (in step S52). In step S52, as described above using FIG. 6 as the example, the second specifying unit 24-2 inverts the position (“X₁, Y₁” in FIG. 6) of the moving body, which is estimated as the virtual image by the first specifying unit 24-1, with respect to the travelling direction of the subject vehicle while the origin is the reflection point R of the radio wave used when the position of the moving body is detected. Accordingly, the second specifying unit 24-2 predicts the position (“X₁′, Y₁′” in FIG. 6) where the target moving body originally exists. Then, the second specifying unit 24-2 determines whether or not the inverted position of the moving body, that is, the position “X₁′, Y₁′” where the target moving body originally exists is within the blind spot region (in step S54).

In step S54, in the case where it is determined that the predicted position, which is predicted as the position where the moving body estimated as the virtual image originally exists in step S52, is within the blind spot region (Yes in step S54), this moving body estimated as the virtual image (in FIG. 6, the other vehicle that exists ahead of the subject vehicle on the right side) is determined as the virtual image as estimated by the first specifying unit 24-1 in step S50 (in step S56). Subsequently, the process proceeds to the subsequent process in step S60. In subsequent step S60, the assistance performing unit 25 sets the moving body, which is determined as the virtual image in step S56, to be removed from the assistance target so as not to be included in the assistance target. Accordingly, when the driving assistance is performed in step S80 described below, the driving assistance does not performed on the virtual image.

On the other hand, in step S54, in the case where it is determined that the predicted position is not within the blind spot region (No in step S54), there is a high possibility of an erroneous estimation result by the first specifying unit 24-1 in step S50. Accordingly, the second specifying unit 24-2 estimates that this moving body, which is determined as the assistance target, is not the virtual image and proceeds to the subsequent process in step S70 without setting of removal from the assistance target.

Before the driving assistance is performed, the assistance performing unit 25 determines whether or not the virtual-image determination process in step S40 is performed on all the moving bodies determined as the assistance target step S30 (in step S70). In step S70, in the case where it is determined that the virtual-image determination process is not terminated with respect to all the assistance targets (No in step S70), the process returns to the process in step S40. On the other hand, in the case where it is determined that the virtual-image determination process is terminated with respect to all the assistance targets in step S70 (Yes in step S70), the assistance performing unit 25 performs the driving assistance on the assistance targets excluding the moving body specified by the first specifying unit 24-1 in step S40 (that is, the moving body estimated as the virtual image) (in step S80). In step S80, the driving assistance to be performed includes the assistance indicating that the position of the assistance target exists in either of the right and left directions with respect to the subject vehicle. Subsequently, this process terminates.

Here, in step S30 of FIG. 7 and FIG. 8 described above, the assistance-target determining unit 23 may determine whether or not the condition where the lateral position y of the moving body with respect to the subject vehicle is within the predetermined threshold value (|y|<thY) as illustrated in FIG. 4 is satisfied in addition to the condition where the intersecting angle θ is within the predetermined range (θ1<θ<θ2) as illustrated in FIG. 3. In this case, in step S30, in the case where the assistance-target determining unit 23 determines that the speed-vector intersecting angle θ is within the predetermined range (θ1<θ<θ2) and the condition where the lateral position y of the moving body with respect to the subject vehicle is within the predetermined threshold value (|y|<thY) is satisfied, the process proceeds to the subsequent process in step S40. On the other hand, in step S30, in the case where the assistance-target determining unit 23 determines that one of the condition where the speed-vector intersecting angle θ is within the predetermined range (θ1<θ<θ2) or the condition where the lateral position y of the moving body with respect to the subject vehicle is within the predetermined threshold value (|y|<thY) is not satisfied, this process terminates.

Before the driving assistance is performed in step S80 of FIG. 7 and FIG. 8 described above, the assistance performing unit 25 may employ a control that determines the degree of risk to the assistance target and then performs the driving assistance in the case where the degree of risk is high. For example, the assistance performing unit 25 may calculate the collision prediction time (D/V) based on the distance D to the assistance target approaching the subject vehicle from the lateral direction and the relative speed V between the subject vehicle and the assistance target and then determine whether or not the calculated collision prediction time is smaller than predetermined threshold value y. Here, in the case where it is determined that the collision prediction time is equal to or more than the predetermined threshold value y, the assistance performing unit 25 recognizes that the degree of risk is low. In step S80, the process is terminated without performing the driving assistance. On the other hand, in the case where it is determined that the collision prediction time is smaller than the predetermined threshold value y, the assistance performing unit 25 recognizes that the degree of risk is high and then performs the driving assistance in step S80.

Further, before the driving assistance is performed in step S80 of FIG. 7 and FIG. 8 described above, the assistance performing unit 25 may determine whether or not the assistance target exists within the dangerous region set in the predetermined range ahead of the subject vehicle instead of the comparison process with the collision prediction time or in addition to this comparison process. Here, in the case where it is determined that the assistance target exists within the dangerous region, the assistance performing unit 25 subsequently proceeds to the process in step S80. On the other hand, in the case where it is determined that the assistance target does not exist within the dangerous region, the assistance performing unit 25 terminates the process.

As just described, the driving assistance apparatus according to the embodiment allows properly removing the virtual image of the assistance target approaching the subject vehicle from the lateral direction in the intersection, thus consequently providing the effect that allows reducing the memory amount and the communication volume needed for the driving assistance process.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A driving assistance apparatus, comprising:
a moving-body detecting unit configured to detect a position of a moving body that exists at a vicinity of a subject vehicle via a radio wave, the subject vehicle being a vehicle on which the driving assistance apparatus is mounted;
a wall-position acquiring unit configured to acquire a position of a wall that exists at a vicinity of the subject vehicle;
an assistance-target determining unit configured to determine whether or not the moving body detected by the moving-body detecting unit is an assistance target that exists ahead of the subject vehicle and approaches the subject vehicle from a lateral direction;
a first specifying unit configured to determine whether or not the wall is positioned on a straight line connecting between a position of the moving body and the position of the subject vehicle regarding the moving body determined as the assistance target by the assistance-target determining unit, so as to specify the moving body with the wall positioned on the straight line; and
an assistance performing unit configured to perform driving assistance on an assistance target excluding the moving body specified by the first specifying unit.

2. The driving assistance apparatus according to claim 1, further comprising
a second specifying unit configured to:
invert a position of the moving body specified by the first specifying unit with respect to a travelling direction of the subject vehicle while a reflection point of a radio wave used when the position of the moving body is detected is used as a basing point; and
determine whether or not the inverted position of the moving body is within a blind spot region of the subject vehicle, so as to specify the moving body within the blind spot region, wherein
the assistance performing unit is configured to perform driving assistance on an assistance target excluding the moving body specified by the second specifying unit.

3. The driving assistance apparatus according to claim 1, wherein
the driving assistance includes assistance indicating that a position of the assistance target exists in either of right and left directions with respect to the subject vehicle.

4. The driving assistance apparatus according to claim 2, wherein
the driving assistance includes assistance indicating that a position of the assistance target exists in either of right and left directions with respect to the subject vehicle.

5. The driving assistance apparatus according to claim 1, wherein
the assistance-target determining unit is configured to:
calculate an intersecting angle formed by a travelling direction of the moving body and a travelling direction of the subject vehicle while an origin is a center of a vehicle-width direction of the subject vehicle; and
determine the moving body satisfying a condition where the intersecting angle is within a predetermined range as the assistance target.

6. The driving assistance apparatus according to claim 2, wherein
the assistance-target determining unit is configured to:
calculate an intersecting angle formed by a travelling direction of the moving body and a travelling direction of the subject vehicle while an origin is a center of a vehicle-width direction of the subject vehicle; and
determine the moving body satisfying a condition where the intersecting angle is within a predetermined range as the assistance target.

7. The driving assistance apparatus according to claim 3, wherein
the assistance-target determining unit is configured to:
calculate an intersecting angle formed by a travelling direction of the moving body and a travelling direction of the subject vehicle while an origin is a center of a vehicle-width direction of the subject vehicle; and
determine the moving body satisfying a condition where the intersecting angle is within a predetermined range as the assistance target.

8. The driving assistance apparatus according to claim 4, wherein
the assistance-target determining unit is configured to:
calculate an intersecting angle formed by a travelling direction of the moving body and a travelling direction of the subject vehicle while an origin is a center of a vehicle-width direction of the subject vehicle; and
determine the moving body satisfying a condition where the intersecting angle is within a predetermined range as the assistance target.
